(19) United States
(12) Patent Application Publication
(10) Pub. No.: US 2025/0354606 A1
(43) Pub. Date: Nov. 20, 2025

(54) METHOD FOR CONTROLLING THE POSITION OF A MOVABLE ELEMENT IN A DEVICE OF A VEHICLE TRANSMISSION

(71) Applicant: VALEO EMBRAYAGES, Amiens Cedex 2 (FR)

(72) Inventors: Anthony FILLIETTE, Cergy Pontoise (FR); Mickael BESNARD, Cergy Pontoise (FR); Thierry LANOE, Cergy Pontoise (FR); Ahmed ESMAEIL-SAEID, Cairo (EG)

(73) Assignee: VALEO EMBRAYAGES, Amiens Cedex 2 (FR)

(21) Appl. No.: 19/209,170

(22) Filed: May 15, 2025

(30) Foreign Application Priority Data
May 16, 2024 (FR) FR2404991

(51) Int. Cl. F16H 63/34

(52) U.S. Cl. CPC F16H 63/3466

(57) ABSTRACT

A method for controlling the position of a movable element in a device of a vehicle transmission. The method includes (i) angularly displacing a control plate, (ii) measuring the angular position of a torque output element of an actuator and comparing the measured value with a limiting threshold value (m), and (iii) reducing the rotating speed of the electric motor of the actuator. The method further includes (iv) applying a limited current (Ilim) to the electric motor of the actuator, and (v) stopping the driving of the electric motor when, cumulatively, the value of the limited current (Ilim) is substantially reached, the measured value of the angular position of the torque output element of the actuator corresponds substantially to the desired position, and the angular speed of the torque output element is substantially zero.

The invention relates to a method for controlling the position of a movable element in a device of a vehicle transmission.

The method according to the invention is particularly beneficial in the field of parking lock devices of a vehicle transmission.

Conventionally, a parking lock device of a vehicle transmission comprises a parking gear that is rotatably mechanically connected to at least one wheel of the vehicle. A finger for blocking the rotation of the parking gear is mounted so that it can move between a first “non-park” position in which the finger is disengaged from the parking gear and a second “park” position in which the finger is engaged between two teeth of the parking gear, thus making it possible to block the rotation of the parking gear and thus the movement of the vehicle.

An electromechanical actuator makes it possible to modify the position of the blocking finger as a function of an instruction emitted by a controller. This actuator generally comprises an electric motor, a torque output element directly or indirectly connected to the blocking finger, and a sensor for determining the angular position of the torque output element reflecting the engaged or disengaged position of the blocking finger.

In order to obtain a mechanically stable position of the locking device in an engaged or disengaged position, it is known practice to insert a control plate between the torque output element of the actuator and the blocking finger. This control plate generally comprises a cam profile with at least two concave portions, at least one convex portion being positioned between the two concave portions. A rolling element, which is fixed relative to the transmission, is suitable for being forced to the bottom of one of the concave portions in the static position, ensuring a mechanically balanced position. The two concave portions are respectively associated with the first and second positions of the blocking finger.

It is important to ensure successful engagement of the blocking finger between the teeth of the parking gear in order to immobilize the vehicle. It is also important to transmit this engagement or disengagement information to a control unit.

Only using the sensor for determining the angular position of the torque output element connected to the finger makes it difficult to achieve the accuracy required to ensure successful engagement, in particular due to the assembly tolerances of the actuator on the transmission.

Using the measurement of the current of the electric motor as well provides an indicator of the torque applied by the actuator on the control plate. On the basis of this torque and the knowledge of the shape of the control plate, it is possible to determine whether the desired position of the control plate has been reached.

US 2005/043878 A1 proposes a method for determining the exact position of the control plate, thus reflecting the position of a movable element of the transmission. The method proposed uses an angular position sensor connected to the control plate and a sensor for determining the torque applied by the electric motor in order to pivot the control plate. The values associated with these two sensors are cross-referenced in a control unit, thus making it possible to know the exact position of the movable element of the transmission.

The method described in the aforementioned document has the drawback that it does not take into account the inertia of the rolling element when it travels along the cam path of the control plate, in particular in the descent phases. It is thus possible for the rolling element to go beyond the bottom of the concave portion, which generates a margin of error that is unacceptable and which, in the worst case, can lead to incorrect information about the exact position of the movable element.

It is thus necessary to optimize this margin of error so that it is as small as possible, without any additional cost, that is, without adding further sensors or components.

The invention thus proposes a method for controlling the position of a movable element in a device of a vehicle transmission, the device comprising an element that is able to move between a first position and a second position, an actuator for driving the movable element between the first and second positions comprising an electric motor, a torque output element, a sensor for determining the current consumed by the electric motor, a sensor for determining the angular position of the torque output element, a control plate positioned between the torque output element of the actuator and the movable element, said plate comprising a cam profile with at least two concave portions, and at least one convex portion positioned between the two concave portions, and a rolling element suitable for being forced to the bottom of one of the concave portions in a static position, the bottoms of the two concave portions being respectively associated with the first and second positions of the movable element, the method being characterized in that it comprises the following steps:
i. angularly displacing the control plate (10) by driving the electric motor of the actuator, thus allowing the rolling element (16) to leave the first concave portion (11) in the direction of the second concave portion (13),
ii. measuring the angular position of the torque output element of the actuator and comparing the measured value with a limiting threshold value (m) and, if the measured value is greater than the limiting threshold value (m),
iii. reducing the rotating speed of the electric motor of the actuator,
iv. applying a limited current (Ilim) to the electric motor of the actuator,
v. stopping the driving of the electric motor when, cumulatively, the value of the limited current (Ilim) is substantially reached, the measured value of the angular position of the torque output element of the actuator corresponds substantially to the second position, and the angular speed of the torque output element is substantially zero.

One of the advantages of the invention is that instead of relying solely on the measured angle of the torque output element of the actuator to determine whether the final position has actually been reached, the current consumed and the speed of the electric motor of the actuator act to ensure that the mechanism will stop in the correct position, that is, a mechanically balanced position.

This method makes it possible to achieve an accuracy target of plus or minus 1.5° without increasing the manufacturing cost of the device.

Another advantage of the present invention is that it is not necessary to perform training on the position of the control plate on the vehicle assembly lines. The position is controlled in real time in order to automatically stop the control plate by limiting the inertia and torque available around the desired position.

The method according to the invention also has the advantage of adapting to a movement of the angular position sensor of the torque output element of the actuator due to the temperature or to the removal or replacement of the actuator for example.

Within the meaning of the invention, rolling element denotes an element that is suitable for moving or sliding along the cam surface, regardless of its structure; the rolling element can also be a resilient strip with a bead serving as a rolling element.

According to the invention, the device also comprises a parking gear that is rotatably mechanically connected to at least one wheel of the vehicle.

According to the invention, the movable element is a finger for blocking the rotation of the parking gear, which is mounted so that it can move between a first “non-park” position in which the finger is disengaged from the parking gear and a second “park” position in which the finger is engaged between two teeth of the parking gear. In other words, these two positions correspond to locked and unlocked positions of the parking gear. The two concave portions of the control plate are respectively associated with the first and second positions of the blocking finger.

According to the invention, when the rolling element passes from the first position to the second position, the control plate moves through an angular range α. This range is for example between 28.5° and 31.5°, and preferably 30°. For example, 0° corresponds to the first position and 30° corresponds to the second position.

According to an additional feature of the invention, the limiting threshold value m is a value in the angular range α and is reached after 80% of the angular displacement of the control plate. In other words, the limitation applies in the last 20% of the angular displacement of the control plate 10.

According to another feature of the invention, the rolling element reaches the second position with a deviation e relative to the bottom of the concave surface. This deviation e corresponds to the torque generated by the electric motor of the actuator with the limited current. For example, the deviation e is between 0.3° and 0.5°. The rolling element is thus “straining” at the ascending slope of the second concave portion but is prevented from going further due to the limited current.

In other words, due to the invention, it is ensured that the rolling element cannot go much further than the bottom of the concave portion into which it is required to move. This point is detected using threshold values of the current consumed by the electric motor, the angular speed and the angular position of the torque output element of the actuator.

According to the invention, the rotating speed of the electric motor of the actuator is reduced in stages. More specifically, the rotating speed of the electric motor of the actuator is reduced twice. For example, the rotating speed of the electric motor is reduced for a first time in a range of between 80% and 90% of the angular displacement of the control plate. The rotating speed of the electric motor is reduced for a second time, to a greater extent, for example in a range of between 90% and 100% of the angular displacement of the control plate.

This limitation in stages makes it possible to limit inertia and avoid going beyond desired positions. The slower speed on the approach to the second position makes it possible to come close to static conditions, that is, the current then depends mainly on the reaction of the shape of the concave portion.

According to the invention, the rotating speed of the electric motor is reduced by a factor of between 2 and 2.5.

According to the invention, the limited current is less than the current necessary for the rolling element to leave one of the concave portions. This has the effect of preventing the rolling element from going further than the desired position.

The present invention is described in relation to a parking lock device of a vehicle transmission but is in no way limited thereto. For example, the invention can also apply to a device comprising a system for changing gears based on the angular position of the torque output element of the actuator. In this case, each gear is associated with the bottom of a concave portion of the cam profile of the control plate.

Further features and advantages of the invention will become apparent on reading the following description of a detailed exemplary embodiment, with reference to the appended figures:

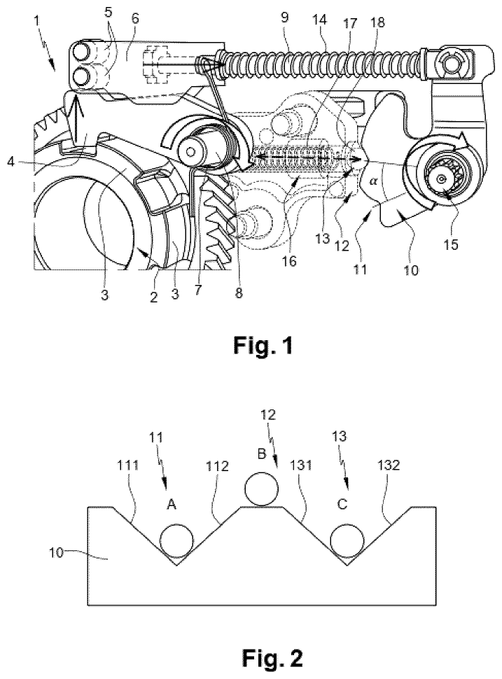

FIG. 1 shows a parking lock device of a transmission of a vehicle according to the invention;

FIG. 2 illustrates the operation of the mechanism of the rolling element on the control plate;

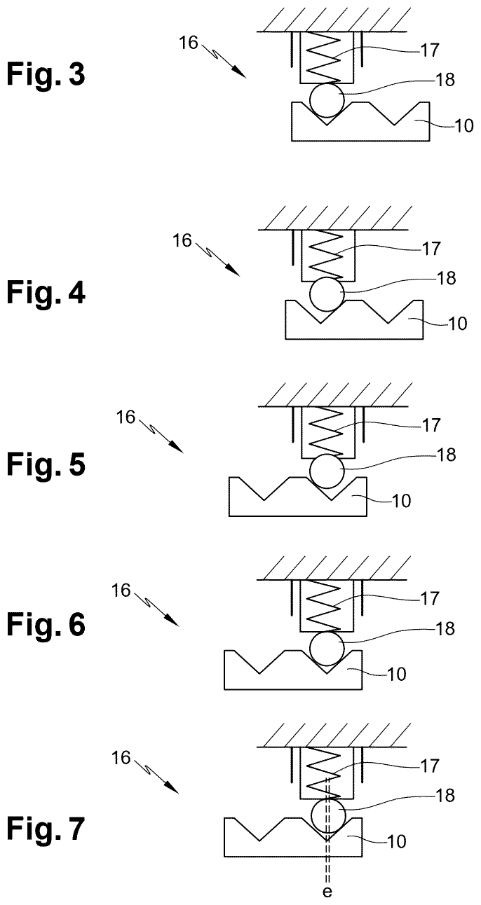

FIG. 3 to FIG. 7 schematically show the different steps of the rolling element along the cam path of the control plate;

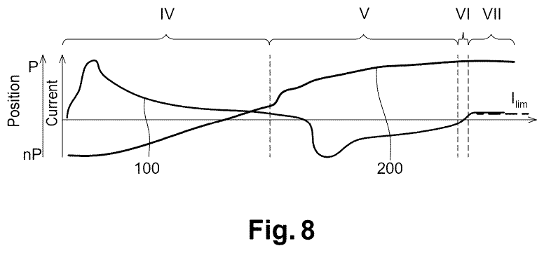

FIG. 8 shows a graph of the movement of the rolling element along the cam path of the control plate between its two positions as a function of the current consumed by the electric motor of the actuator.

It should be noted that the figures disclose the invention in a sufficiently detailed manner for the implementation thereof, said figures helping to better define the invention as required. However, the invention should not be limited to the embodiment disclosed in the description.

The parking lock device 1 in FIG. 1 is positioned partially inside the transmission. It comprises a parking gear 2 that is rotatably mechanically connected to at least one wheel of the vehicle.

A parking pawl is pivotably mounted about a shaft 8. The parking pawl is provided at one end thereof with a blocking finger 4 designed to engage in a recess between two teeth of the parking gear 2.

The finger 4 for blocking the rotation of the parking gear is mounted so that it can move between a first “non-park” position in which the finger is disengaged from the parking gear 2 and a second “park” position, as shown in FIG. 1, in which the finger is engaged between two teeth of the parking gear. The rotation of the parking gear is thus blocked and the vehicle is immobilized.

The blocking finger 4 is held in, a returned to, an unlocked position by means of an elastic return member 7, for example in the form of a torsion spring, arranged around the shaft 8 of the parking pawl.

A fork head 6 is slidably mounted so that it can alternately adopt a locked position in which the fork head 6 pushes the blocking finger 4 into an engaged position, that is, into the recess in the parking gear 2, in order to block the transmission output and thus park the vehicle.

The fork head 6 is able to adopt another position, referred to as the unlocked position, in which it does not interfere with the blocking finger 4, allowing said parking pawl to be returned by the elastic return member 7 to its unlocked position of the blocking finger 4.

The fork head 6 is mounted at the end of a guide rod 9. A compression spring 14 is mounted around the rod 9 in order to push said fork head 6 into the locked position.

The fork head 6 comprises a first roller and a second roller 5, each mounted so that it can rotate freely about an axis, the first roller being positioned so that it rolls against the parking pawl when the fork head 6 passes to the locked position.

An electromechanical actuator (not shown) makes it possible to modify the position of the blocking finger 4 as a function of an instruction emitted by a controller. This actuator comprises an electric motor, a torque output element directly or indirectly connected to the blocking finger, and a sensor for determining the angular position of the torque output element reflecting the engaged or disengaged position of the blocking finger.

In order to obtain a mechanically stable position of the locking device in an engaged or disengaged position, a control plate 10 is interposed between the torque output element of the actuator and the blocking finger 4. The torque output element of the actuator engages in an interface 15 of the control plate 10, for example by means of a male/female coupling.

This control plate 10 comprises a cam profile with at least two concave portions 11, 13, and at least one convex portion 12 positioned between the two concave portions 11, 13. A rolling element 16, also referred to as a ball and spring system in this instance, is suitable for being forced to the bottom of one of the concave portions 11, 13 in the static position, ensuring a mechanically balanced position. The two concave portions 11, 13 are respectively associated with the first and second positions of the blocking finger.

The control plate 10 is suitable for being pivoted under the effect of the torque supplied by the actuator. When the rolling element 16 passes from the first position to the second position, the control plate 10 moves through an angular range α, for example of 30°.

The ball and spring system, which is mounted fixedly on the transmission, comprises an elastic element 17 in the form of a spring at the end of which is a ball 18. This ball 18 is in contact with the cam profile of the control plate 10.

The interaction between the rolling element 16 and the control plate 10 is illustrated in FIG. 2.

The mechanical means for retaining the control plate 10 in its “park” and “non-park” operating positions is schematically shown with the ball 18 only. The operating zone of the control plate 10 is defined by the cam path, which comprises the two concave portions 11, 13 and the convex portion 12.

Under the effect of torque supplied by the actuator, the control plate pivots in front of the ball 18, which moves in a substantially radial direction relative to the control plate 10. When the control plate rotates, its operating zone travels. The ball 18 advances in the concave portions 11, 13 of the control plate 10 as it passes.

The ball is shown three times, in positions A, B, C respectively, in the two concave portions and on the convex portion. For example, A is considered to be the first so-called “non-park” position, C is considered to be the second so-called “park” position, and B is considered to be an intermediate position of the ball on the convex portion of the cam path.

The ball 18 can pass from the first concave portion 11 to the second concave portion 13 and vice versa as a function of the direction of rotation of the electric motor of the actuator. The invention applies to both directions of rotation.

The first concave portion 11 comprises two slopes 111 and 112, and the second concave portion 13 comprises two slopes 131 and 132. The convex portion is partially defined by the slopes 112 and 131.

When the ball 18 passes from the first concave portion 11 to the second concave portion 13, the slopes 111 and 131 are referred to as descending and the slopes 112 and 132 are referred to as ascending. Conversely, when the ball 18 passes from the second concave portion 13 to the first concave portion 11, the slopes 111 and 131 are referred to as ascending and the slopes 112 and 132 are referred to as descending. When the ball 18 travels along an ascending slope, the electric motor of the actuator generates positive torque, and when the ball 18 travels along a descending slope, the electric motor of the actuator generates negative torque.

By knowing the geometry of the cam path of the control plate 10, it is thus possible to know the torque curve applied by the electric motor of the actuator as a function of the angular position of the control plate 10.

The advantage of this control plate 10 is that if the torque from the electric motor of the actuator ceases, the control plate 10 is thus mechanically retained in the “park” or “non-park” position.

The different steps of the method according to the invention will now be described.

FIG. 3 shows the control plate 10 in its first “non-park” position in an initial situation, that is, the electric motor of the actuator is not powered. The torque output element of the actuator coupled to the control plate 10 is also in its “non-park” position. The angular sensor of the torque output element of the actuator thus measures the “non-park” position with two margins of error, a first margin linked to the assembly tolerances of the actuator on the transmission and a second margin linked to the sensor itself.

FIG. 4 shows the control plate 10 when it starts to move, that is, when the ball 18 passes from the first concave portion 11 to the second concave portion 13. In FIG. 4, the ball is on the ascending slope 112 of the first concave portion 11 in the direction of the crest of the convex portion 12. In this position, and as seen above, the torque generated by the electric motor is positive and the current consumed by the electric motor is also positive.

FIG. 5 shows the control plate 10 in a position in which the ball 18 has gone past the crest of the convex portion 12 and is on the descending slope 131 of the second concave portion 13. In this position, the ball 18 is “overcome”, that is, the torque generated by the electric motor becomes negative and the current consumed by the electric motor is also negative.

So that the device is not carried away by the descending slope 131, the angular position of the torque output element of the actuator is measured and this measurement is compared with the limiting threshold value m.

If the measured value of the angular position is greater than the limiting threshold value m, the rotating speed of the electric motor of the actuator is reduced when the ball 18 is approaching the bottom of the second concave portion 13 and a limited current Iₗᵢₘ is applied to the electric motor of the actuator.

The descent of the ball 18 must be slowed because the current consumed by the electric motor does not reflect the position of the ball 18 on the cam path of the control plate 10 due to the dynamic effects. In other words, the rotating speed of the electric motor must be reduced so that the dynamic effects are negligible and the current consumed reflects the journey of the ball 18 on the cam path of the control plate 10.

The limiting threshold value m is a calibration angular value that is stored in the controller of the actuator. The limiting threshold value m is reached when the last 20% of the angular displacement of the control plate 10 are reached.

For example, when the ball 18 passes from the first position to the second position, the control plate 10 moves through an angular range α that is 30°. In other words, the rotating speed of the electric motor is reduced and the limited current Iₗᵢₘ is applied on substantially the last 20% of the angular displacement of the control plate 10, i.e. between 24° and 30°, in other words over 6°.

The rotating speed of the electric motor is reduced by a factor of between 2 and 2.5. For example, the rotating speed of the electric motor changes from 12,800 rpm to 5,600 rpm. The rotating speed of the electric motor of the actuator is reduced in stages, for example twice. In the present case, the rotating speed of the electric motor of the actuator is reduced for a first time in a range of between 80% and 90% of the angular displacement of the control plate 10, i.e. between 24° and 27°, in other words over 3°. The rotating speed of the electric motor of the actuator is reduced for a second time, to a greater extent, in a range of between 90% and 100% of the angular displacement of the control plate 10, i.e. between 27° and 30°, in other words over 3°.

The limited current value Iₗᵢₘ is a calibration value that is stored in the controller of the actuator. For example, the limited current value is 1.3 A.

FIG. 6 shows the control plate 10 in a position in which the ball 18 reaches the bottom of the second concave portion 13. The torque generated and the current consumed by the electric motor reverse and become substantially close to zero. The torque output element of the actuator coupled to the control plate 10 is in its “park” position. The angular sensor of the torque output element of the actuator thus measures the “park” position with two margins of error, a first margin linked to the assembly tolerances of the actuator on the transmission and a second margin linked to the sensor itself.

FIG. 7 shows the control plate 10 in a desired stopping position, that is, in a position in which the ball 18 is slightly beyond the bottom of the second concave portion 13, which is a deviation zone e relative to the position of the bottom of the second concave portion 13.

The fact that a limited current is applied to the electric motor of the actuator prevents the ball 18 from going back up the slope 132 and makes it possible to ensure that it has gone through the bottom of the second concave portion 13 and is in the deviation zone e.

The driving of the electric motor is stopped when, cumulatively, the value of the limited current Iₗᵢₘ is substantially reached, the measured value of the angular position of the torque output element of the actuator corresponds substantially to the second “park” position of the ball 18, and the angular speed of the torque output element of the actuator is substantially zero. “Substantially” means that there is a tolerance threshold for each of these criteria. These tolerance thresholds are calibration values that are stored in the controller of the actuator.

In the present case, the limited current Iₗᵢₘ is considered to have been reached when it is between 1.2 A and 1.4 A, which means that the rolling element 16 or the ball 18 is “straining” at the ascending slope of the second concave portion and is in the acceptable deviation zone e.

In the present case, the second position of the rolling element 16 is considered to have been reached when the angular position sensor of the torque output element of the actuator is ±2.5° relative to the position stored in the controller.

Zero angular speed of the torque output element of the actuator is considered to have been reached with a tolerance threshold of ±0.5 rad/s, which allows low inertia. The angular speed of the output element of the actuator is derived from the angular position thereof.

The control plate 10 in thus stopped when the ball 18 is slightly beyond the bottom of the second concave portion 13, which is a deviation e relative to the bottom of the second concave portion 13. This deviation e represents the final angular position of the control plate 10 that corresponds to the torque generated by the actuator with the limited current Iₗᵢₘ. For example, this deviation e is between 0.3° and 0.5°.

The angular sensor of the torque output element of the actuator thus measures the “park” position with two margins of error, a first margin linked to the assembly tolerances of the actuator on the transmission and a second margin linked to the sensor itself. The deviation e that is desired compensates for these two margins of error in order to ensure satisfactory positioning of the rolling element in the desired position.

FIG. 8 shows on one and the same graph the curve 100 of the current consumption of the electric motor of the actuator as a function of the journey of the ball 18 on the cam path of the control plate 10, and the curve 200 of the position of the control plate between its “park” and “non-park” positions.

The graph is split into four phases that correspond to the different steps shown in FIG. 4 to FIG. 7.

The curve 100 shows that at the start of the movement of the control plate 10, there is a positive peak of current consumed corresponding to the force necessary for the ball 18 to overcome the ascending slope 112 of the first concave portion 11. Next, the current consumed drops until it becomes negative, meaning that the ball is on the descending slope 131 of the second concave portion 13. Next, the current consumed becomes positive again, which means that the ball 18 has passed through the bottom of the second concave portion 13 and is starting to travel along the ascending slope 132. Due to the limited current Iₗᵢₘ applied to the electric motor, the ball 18 can no longer rise and stops in the desired position with the deviation e, which ensures that the ball is in the desired position.

Although the invention has been described in connection with a particular embodiment, it is quite clear that it is by no means limited thereto and that it includes all the technical equivalents of the means described.

In the claims, the reference signs between parentheses should not be interpreted as limiting the claim.

1. Method for controlling the position of a movable element in a device of a vehicle transmission, the device comprising:
an element that is able to move between a first position and a second position,
an actuator for driving the movable element between the first and second positions, comprising an electric motor, a torque output element, a sensor for determining the current consumption of the electric motor, and a sensor for determining the angular position of the torque output element,
a control plate positioned between the torque output element of the actuator and the movable element, said plate comprising a cam profile with at least two concave portions, at least one convex portion positioned between the two concave portions, and a rolling element suitable for being forced to the bottom of one of the concave portions in a static position, the bottoms of the two concave portions being respectively associated with the first and second positions of the movable element, wherein
the method comprises the following steps:
i. angularly displacing the control plate by driving the electric motor of the actuator, thus allowing the rolling element to leave the first concave portion in the direction of the second concave portion,
ii. measuring the angular position of the torque output element of the actuator and comparing the measured value with a limiting threshold value and, if the measured value is greater than the limiting threshold value,
iii. reducing the rotating speed of the electric motor of the actuator,
iv. applying a limited current to the electric motor of the actuator,
v. stopping the driving of the electric motor when, cumulatively, the value of the limited current is substantially reached, the measured value of the angular position of the torque output element of the actuator corresponds substantially to the second position, and the angular speed of the torque output element is substantially zero.

2. Method according to claim 1, wherein when the rolling element passes from the first position to the second position, the control plate moves through an angular range α, for example of between 28.5 and 31.5°, and preferably of 30°.

3. Method according to claim 2, wherein the limiting threshold value is a value in the angular range α and is reached after 80% of the angular displacement of the control plate.

4. Method according to claim 1, wherein the rolling element reaches the second position with a deviation relative to the bottom of the concave surface, this deviation corresponding to the torque generated by the electric motor of the actuator with the limited current.

5. Method according to claim 4, wherein the deviation is between 0.3° and 0.5°.

6. Method according to claim 1, wherein the rotating speed of the electric motor of the actuator is reduced in stages.

7. Method according to claim 6, wherein the rotating speed of the electric motor of the actuator is reduced for a first time in a range of between 80% and 90% of the angular displacement of the control plate and for a second time, to a greater extent, in a range of between 90% and 100% of the angular displacement of the control plate.

8. Method according to claim 1, wherein the rotating speed of the electric motor is reduced on the basis of a factor of between 2 and 2.5.

9. Method according to claim 1, wherein the limited current is less than the current required for the rolling element to leave one of the concave portions.

10. Method according to claim 2, wherein the rolling element reaches the second position with a deviation relative to the bottom of the concave surface, this deviation corresponding to the torque generated by the electric motor of the actuator with the limited current.

11. Method according to claim 2, wherein the rotating speed of the electric motor of the actuator is reduced in stages.

12. Method according to claim 2, wherein the rotating speed of the electric motor is reduced on the basis of a factor of between 2 and 2.5.

13. Method according to claim 2, wherein the limited current is less than the current required for the rolling element to leave one of the concave portions.

14. Method according to claim 3, wherein the rolling element reaches the second position with a deviation relative to the bottom of the concave surface, this deviation corresponding to the torque generated by the electric motor of the actuator with the limited current.

15. Method according to claim 3, wherein the rotating speed of the electric motor of the actuator is reduced in stages.

16. Method according to claim 3, wherein the rotating speed of the electric motor is reduced on the basis of a factor of between 2 and 2.5.

17. Method according to claim 3, wherein the limited current is less than the current required for the rolling element to leave one of the concave portions.

18. Method according to claim 4, wherein the rotating speed of the electric motor of the actuator is reduced in stages.

19. Method according to claim 4, wherein the rotating speed of the electric motor is reduced on the basis of a factor of between 2 and 2.5.

20. Method according to claim 4, wherein the limited current is less than the current required for the rolling element to leave one of the concave portions.
